(19) United States
(12) Patent Application Publication
(10) Pub. No.: US 2024/0055874 A1
(43) Pub. Date: Feb. 15, 2024

(54) POWER STORAGE MANAGEMENT DEVICE, POWER STORAGE DEVICE, AND METHOD FOR MANAGING POWER STORAGE UNIT

(71) Applicant: MUSASHI SEIMITSU INDUSTRY CO., LTD., TOYOHASHI-SHI, AICHI (JP)

(72) Inventor: Kenji HAMADA, TOYOHASHI-SHI, AICHI (JP)

(21) Appl. No.: 18/270,946

(22) PCT Filed: Feb. 8, 2021
(86) PCT No.: PCT/JP2021/004518

§ 371 Date: Jul. 5, 2023

(51) Int. Cl. H02J 7/00; H02M 3/335; H02M 1/00; H01M 10/42; H01M 50/51

(52) U.S. Cl. CPC H02J 7/0014; H02M 3/33576; H02M 1/0009; H01M 10/425; H01M 50/51; H01M 2010/4271

(57) ABSTRACT

A power storage management device includes: a voltage detection unit; a current detection unit; and a voltage equalization circuit that includes a plurality of transformers including a first winding connected in parallel with each of the power storage elements and a second winding connected in parallel with the power storage unit and the current detection unit, a plurality of switch units including at least one of a first switch connected in series to the first winding and a second switch connected in series to the second winding. When a first abnormality determination condition is satisfied, a process corresponding to an abnormality detection of the current detection unit is performed, the first abnormality determination condition including the necessary condition that a detection result of the current detection unit caused by the on/off operation of the switch units corresponding to the target power storage elements is outside a normal current range.

### TECHNICAL FIELD

This invention relates to a power storage management device, a power storage device, and a method for managing a power storage unit.

### BACKGROUND ART

Conventionally, a power storage device (e.g., a battery pack) equipped with a power storage unit (e.g., a battery assembly) and a current detection unit has been known. The current detection unit is connected in series with the power storage unit and detects the current flowing through the power storage unit. The current detected by the current detection unit is used, for example, to determine the charge/discharge status of the power storage unit. In this case, the current detection unit may fail to normally detect the current flowing through the power storage unit, for example, due to a short circuit or open circuit in the internal circuit provided in the current detection unit or a component failure.

Therefore, there is a conventional power storage device equipped with a function to determine whether the current detection unit is normal or abnormal. This conventional power storage device has a voltage divider resistor and a relay connected in series with each other, and the voltage divider resistor and the relay are connected in parallel with the power storage unit and the current detection unit. When the relay is turned on, current flows through both the power storage unit and the voltage divider resistor. The presence or absence of an abnormality in the current detection unit is determined based on the voltage divider voltage of the voltage divider resistor and the detection results of the current detection unit at that time (see, Patent Document 1 below).

### CITATION LIST

### Patent Literature

Patent Document 1: JP 2019-029236 A

### SUMMARY OF INVENTION

### Technical Problem

In the above conventional power storage device, in order to accurately detect the current change when the relay switches from the off state to the on state, it is necessary to set the resistance value of the voltage divider resistor to a certain small value to increase the current flowing through the power storage unit and the current detection unit. However, as the current set to flow through the power storage unit and the current detection unit is increased, the power loss due to the voltage divider resistor increases, resulting in a decrease in the remaining capacity of the power storage device.

An object of the present invention is to provide a power storage management device, a power storage device, and a method for managing a power storage unit, capable of solving the above-mentioned problems.

### Solution to Problem

In order to achieve the above-mentioned purpose, a power storage management device according to an aspect of the present invention is a power storage management device that manages a power storage unit in which a plurality of power storage elements are connected in series, including: a voltage detection unit that detects a voltage of each of the plurality of power storage elements; a current detection unit that is connected in series with the power storage unit to detect a current flowing through the power storage unit; a voltage equalization circuit that includes a plurality of transformers provided corresponding to each of the plurality of power storage elements, each of the plurality of transformers including a first winding connected in parallel with each of the power storage elements and a second winding connected in parallel with the power storage unit and the current detection unit, and a plurality of switch units provided corresponding to each of the plurality of power storage elements, each of the plurality of switch units including at least one of a first switch connected in series to the first winding and a second switch connected in series to the second winding, to reduce the voltage difference among the plurality of power storage elements; an on/off control unit that selects some of power storage elements among the plurality of power storage elements as target power storage elements and causes the switch units corresponding to the target power storage elements to perform on/off operation; and a first abnormality processing unit that performs a process corresponding to an abnormality detection of the current detection unit when a first abnormality determination condition is satisfied, the first abnormality determination condition including the necessary condition that a detection result of the current detection unit caused by the on/off operation of the switch units is outside a normal current range corresponding to the voltage of the target power storage elements and the voltage of the power storage unit based on the detection result of the voltage detection unit.

In this power storage management device, upon an on/off operation of some of the switch units constituting the voltage equalization circuit, a current is transferred between the target power storage elements corresponding to the switch unit and the power storage unit. As a result, the current flowing through the power storage unit changes. In this case, if the current detection unit is normal, the detection result of the current detection unit will be within the normal current range corresponding to the voltage of the target power storage element and the voltage of the power storage unit based on the detection result of the voltage detection unit, and if the current detection unit is abnormal, the detection result of the current detection unit will be outside the normal current range. The inventor newly discovered that the presence or absence of an abnormality in the current detection unit can be determined by focusing on the voltage change in the target power storage elements caused by the on/off operation of the voltage equalization circuit and the detection result of the current detection unit. As a result, the present power storage management device is capable of determining the presence or absence of an abnormality in the current detection unit by using the voltage equalization circuit, without providing a separate current path dedicated to determining the presence or absence of an abnormality in the current detection unit.

In the above power storage management device, the first abnormality determination condition may include the necessary conditions that there is a voltage change in the target power storage elements caused by the on/off operation of the switch units and that the detection result of the current detection unit is outside the normal current range. This power storage management device is capable of suppressing that the current detection unit is erroneously determined as abnormal when the voltage equalization circuit is abnormal.

The above power storage management device may further include a second abnormality processing unit that performs a process corresponding to an abnormality detection of the voltage equalization circuit when a second abnormality determination condition is satisfied, the second abnormality determination condition including the necessary condition that an amount of voltage change in the target power storage elements caused by the on/off operation of the switch unit is outside the normal voltage range. According to this power storage management device, in addition to an abnormality in the current detection unit, an abnormality in the voltage equalization circuit can also be detected.

In the above power storage management device, the on/off control unit may be configured to select, among the plurality of power storage elements, a power storage element having a voltage outside a reference voltage range that includes an average voltage value obtained by dividing the voltage of the power storage unit by the number of power storage elements as the target power storage elements. This power storage management device operates the switch unit corresponding to the power storage element having a voltage outside the reference voltage range and requiring the voltage equalization process on and off to determine the presence or absence of an abnormality in the current detection unit. As a result, compared to the configuration in which the target power storage element is selected regardless of whether the voltage is within the reference voltage range, this power storage management device can determine the presence or absence of an abnormality in the current detection unit by using the voltage equalization circuit while suppressing the on/off operation of the switch unit, which is essentially unnecessary in the voltage equalization process.

The above power storage management device may further include a third abnormality processing unit that performs a process corresponding to an abnormality detection of the voltage equalization circuit when a third abnormality determination condition is satisfied, the third abnormality determination condition including at least one of the necessary conditions that abnormality detection results of the current detection unit when the same switch of the plurality of switch units is operated on and off multiple times differ from each other and that abnormality detection results of the current detection unit when at least two or more switch units are operated on and off sequentially differ from each other. According to this power storage management device, in addition to an abnormality in the current detection unit, an abnormality in the voltage equalization circuit can also be detected.

In the above power storage management device, when the target power storage elements include a first power storage element and a second power storage element that are adjacent to each other, the on/off control unit may perform the on/off operation of the switch unit corresponding to the first power storage element and the on/off operation of the switch unit corresponding to the second power storage element at different times. For example, when the switch units corresponding to mutually adjacent power storage elements are operated on and off at the same time, the voltage of each power storage element cannot be measured accurately because the voltage drops in the common path cancel each other out, and as a result, it may be impossible to accurately determine the presence or absence of an abnormality in the current detection unit. In contrast, according to this power storage management device, since the on/off operations of the switch units corresponding to the mutually adjacent storage elements (first power storage element and second power storage element) are performed at different times from each other, it is possible to suppress the reduction in the accuracy of determining the presence or absence of an abnormality in the current detection unit.

A power storage device according to an aspect of the present invention is provided with a power storage unit including a plurality of power storage elements connected in series, and a power storage management device of any one of the above. This power storage device is capable of determining the presence or absence of an abnormality in the current detection unit by using a voltage equalization circuit.

Another aspect of the present invention is a method for managing a power storage unit, the power storage unit including: a power storage unit including a plurality of power storage elements connected in series; and a voltage detection unit that detects a voltage of each of the plurality of power storage elements; a current detection unit connected in series with the power storage unit to detect a current flowing through the power storage unit; a voltage equalization circuit that includes a plurality of transformers provided corresponding to each of the plurality of power storage elements, each of the plurality of transformers including a first winding connected in parallel with each of the power storage elements and a second winding connected in parallel with the power storage unit and the current detection unit, and a plurality of switch units provided corresponding to each of the plurality of power storage elements, each of the plurality of switch units including at least one of a first switch connected in series to the first winding and a second switch connected in series to the second winding, to reduce the voltage difference among the plurality of power storage elements, the method including: a step of selecting some of power storage elements among the plurality of power storage elements as target power storage elements and causing the switch unit corresponding to the target power storage elements to perform on/off operation; and a step of performing a process corresponding to an abnormality detection of the current detection unit when a first abnormality determination condition is satisfied, the first abnormality determination condition including the necessary condition that a detection result of the current detection unit caused by the on/off operation of the switch units is outside a normal current range corresponding to the voltage of the target power storage elements and the voltage of the power storage unit based on the detection result of the voltage detection unit. According to this method for managing the power storage unit, it is possible to determine the presence or absence of an abnormality in the current detection unit by using a voltage equalization circuit.

The technology disclosed herein can be implemented in various forms, such as a power storage management device, a power storage device provided with a power storage management device and a power storage unit, methods for managing those devices, computer programs for implementing those methods, a non-temporary recording medium recording the computer programs, among others.

### BRIEF DESCRIPTION OF DRAWINGS

FIG. 1 is an explanatory view schematically illustrating a configuration of a battery device 100 in an embodiment.

FIG. 2 is an explanatory view schematically illustrating an operation of constant current control when one storage battery 12a among a plurality of storage batteries 12 is selected as a target storage battery 12x.

FIG. 3 is an explanatory view illustrating an example of a normal current range table T1.

FIG. 4 is a flowchart illustrating an abnormality determination process performed in the battery device 100 of an embodiment.

FIG. 5 is a flowchart illustrating an on/off control process performed in the battery device 100 of an embodiment.

### DESCRIPTION OF EMBODIMENTS

### A. Embodiment

A-1. Configuration of Battery Device 100:

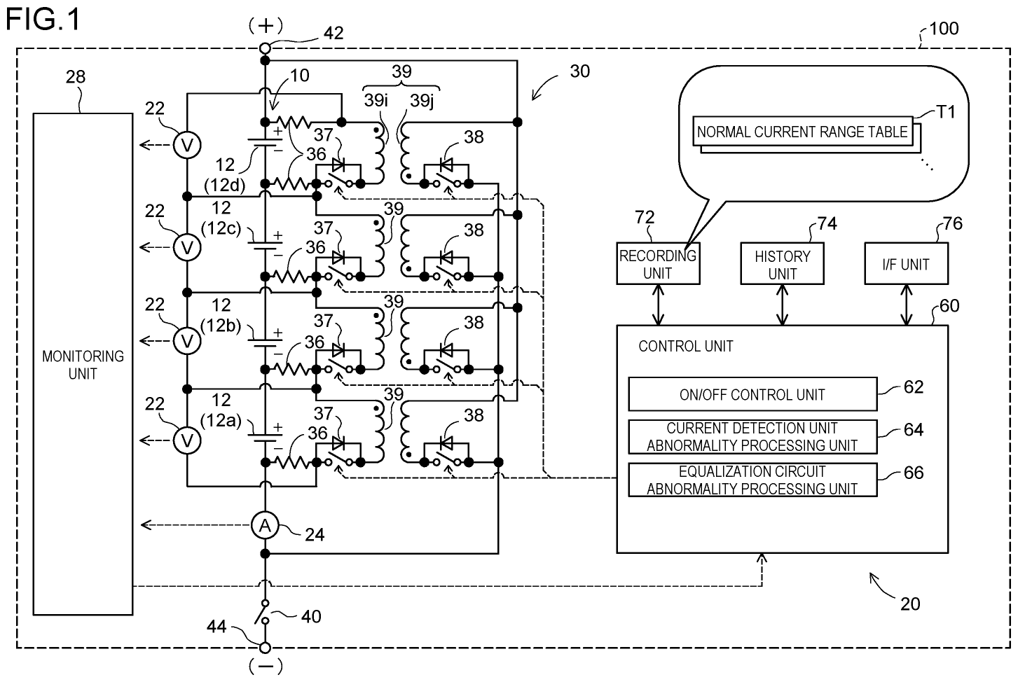

FIG. 1 is an explanatory view schematically illustrating a configuration of a battery device 100 in an embodiment. The battery device 100 includes a battery assembly 10 and a power storage management device 20.

The battery assembly 10 has a configuration in which a plurality of storage batteries 12 are connected in series. In this embodiment, the battery assembly 10 consists of four storage batteries 12 (12a, 12b, 12c, and 12d). The storage battery 12 is, e.g., an iron phosphate lithium-ion battery. The battery assembly 10 is connected to a load and an external power source, not shown, via a positive terminal 42 and a negative terminal 44. The battery assembly 10 is an example of the power storage unit, and the storage battery 12 is an example of the power storage element.

The power storage management device 20 is a device that manages the battery device 100 including the battery assembly 10. The power storage management device 20 includes a voltage detection unit 22, a current detection unit 24, a monitoring unit 28, a voltage equalization circuit 30, a line switch 40, a control unit 60, a recording unit 72, a history unit 74, and an interface (I/F) unit 76. The battery device 100 is an example of the power storage device.

One voltage detection unit 22 is provided for each storage battery 12. Each voltage detection unit 22 is connected in parallel with each storage battery 12, detects the voltage of each storage battery 12, and outputs a signal indicating the voltage detection value to the monitoring unit 28. The current detection unit 24 is connected in series to the battery assembly 10. The current detection unit 24 detects the current flowing through the battery assembly 10 and outputs a signal indicating the current detection value to the monitoring unit 28. The monitoring unit 28 outputs signals indicating the voltage of each storage battery 12 and the current flowing through the battery assembly 10 to the control unit 60 based on the signals received from the voltage detection unit 22 and the current detection unit 24.

The voltage equalization circuit 30 is a circuit that performs constant current control to reduce the voltage difference among the plurality of storage batteries 12 constituting the battery assembly 10 by transferring electric charge among the storage batteries 12. In other words, the voltage equalization circuit 30 is a circuit for executing an active voltage equalization. The voltage equalization circuit 30 is configured to perform voltage equalization for any combination of the storage batteries 12, not limited to a pair of two mutually adjacent storage batteries 12.

That is, the voltage equalization circuit 30 is provided with one transformer 39 for each storage battery 12. Each transformer 39 includes a first winding 39i and a second winding 39j. The first winding 39i of each transformer 39 is connected in parallel with the corresponding storage battery 12. The second winding 39j of each transformer 39 is connected in parallel with the battery assembly 10 and the current detection unit 24. The voltage equalization circuit 30 includes a first switch 37 and a second switch 38, one for each storage battery 12. Each first switch 37 is connected in series with the first winding 39i of the transformer 39 provided for each storage battery 12, and each second switch 38 is connected in series with the second winding 39j of the transformer 39 provided for each storage battery 12. The control unit 60 controls the on/off operation of each first switch 37 and each second switch 38 by a predetermined modulation method (e.g., pulse width modulation (PWM)) to perform constant current control, thereby causing electric charge to be transferred between each storage battery 12 and the battery assembly 10 via the transformer 39. For example, MOSFETs or relays are used as the first switch 37 and the second switch 38. The first switch 37 and the second switch 38 may be collectively referred to as the “switch unit” below.

In this embodiment, each storage battery 12 and the voltage equalization circuit 30 are connected via a wire 36. Specifically, one end of each voltage detection unit 22 is connected to the first winding 39i of each transformer 39, and the connection point is connected to the positive terminal of the storage battery 12 via the wire 36. The other end of each of the voltage detection units 22 is connected to the first switch 37, and the connection point thereof is connected to the negative terminal of the storage battery 12 via the wire 36. Two adjacent storage batteries 12 share a common wire 36 in the transfer of electric charge so that the currents cancel each other out.

The voltage equalization circuit 30 with this configuration is capable of performing constant current control to reduce the voltage difference of each of the plurality of storage batteries 12 by transferring the electric charge among the plurality of storage batteries 12 separately for each of the storage batteries 12. In other words, it is possible to identify at least one storage battery 12 of the plurality of storage batteries 12 in which the difference between the voltage of each of the plurality of storage batteries 12 detected by the voltage detection unit 22 and the average voltage Vave of the plurality of storage batteries 12 is greater than a predetermined value as the target storage battery or target storage batteries 12x, to perform a constant current control that brings the voltage of the target storage battery or target storage batteries 12x closer to the average voltage Vave.

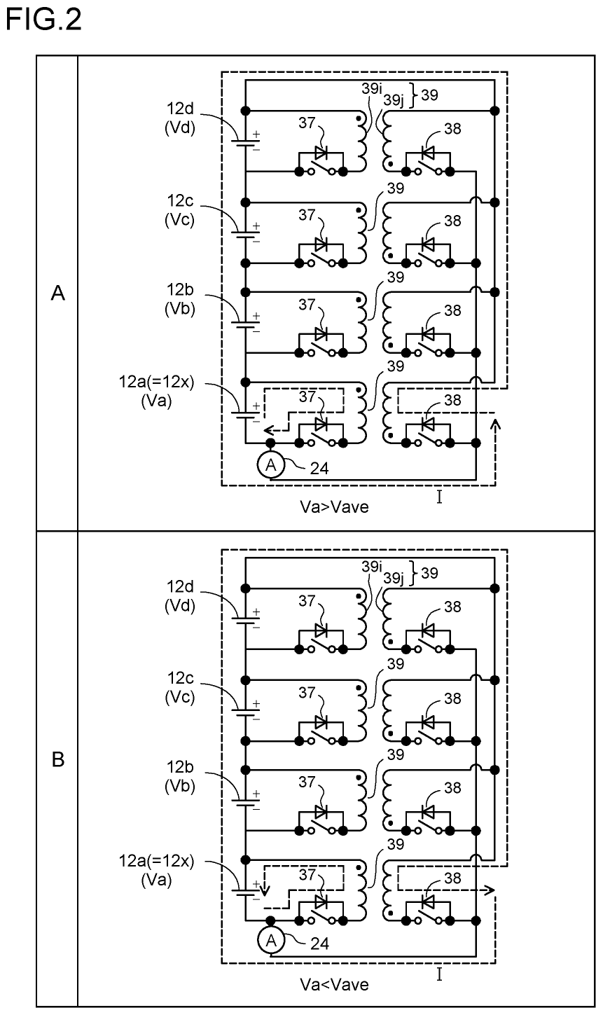

FIG. 2 is an explanatory view schematically illustrating an operation of constant current control when one storage battery 12a among the plurality of storage batteries 12 is identified as the target storage battery 12x. Column A of FIG. 2 shows a state in which the voltage Va of a storage battery 12a, which is the target storage battery 12x, is higher than the average voltage Vave of the storage batteries 12, and voltage equalization is being performed by operating the first switch 37 on and off to transfer electric charge from the target storage battery 12x to the other storage batteries 12. In addition, column B of FIG. 2 shows a state in which the voltage Va of a storage battery 12a, which is the target storage battery 12x, is lower than the average voltage Vave of the storage batteries 12, and voltage equalization is being performed by operating the second switch 38 on and off to transfer electric charge from the other storage batteries 12 to the target storage battery 12x.

The line switch 40 (FIG. 1) is provided between the current detection unit 24 and the negative terminal 44. The line switch 40 is controlled on and off by the control unit 60 to open and close the connection between the battery assembly 10 and a load/external power source.

The control unit 60 is configured by using, e.g., a CPU, a multi-core CPU, or a programmable device (such as a field programmable gate array (FPGA) and a programmable logic device (PLD)) to control the operation of the power storage management device 20. The control unit 60 functions as an on/off control unit 62, a current detection unit abnormality processing unit 64, and an equalization circuit abnormality processing unit 66. The functions of each of these units will be explained in conjunction with the description of the abnormality determination process described below. The current detection unit abnormality processing unit 64 is an example of the first abnormality processing unit, and the equalization circuit abnormality processing unit 66 is an example of the second and third abnormality processing units.

The recording unit 72 is composed of, e.g., ROM, RAM, and a hard disk drive (HDD), and is used to store various programs and data, or as a work area or data storage area when executing various processes. For example, the recording unit 72 stores a computer program for executing the abnormality determination process described below. The computer program is provided, e.g., in the form of a computer-readable recording medium (not shown) such as a CD-ROM, DVD-ROM, and USB memory, and is stored in the recording unit 72 by being installed in the battery device 100.

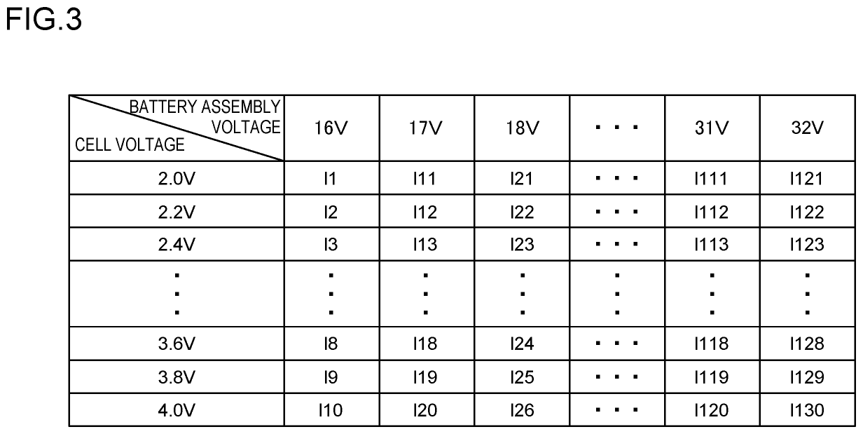

The recording unit 72 also stores a normal current range table T1. The normal current range table T1 is a table used to identify the normal range of the current value flowing through the battery assembly 10 based on the voltage relationship between the storage battery 12 and the battery assembly 10. FIG. 3 is an explanatory view illustrating an example of the normal current range table T1. The normal current range table T1 is a table that associates the terminal voltage of the storage battery 12 (cell voltage), the voltage of the battery assembly 10 (battery assembly voltage), and the normal current range. The normal current range is a numerical range of current flowing through the battery assembly 10 determined by the correspondence between the terminal voltage of the storage battery 12 and the voltage of the battery assembly 10 when the current detection unit 24 and the voltage equalization circuit 30 can operate normally. In FIG. 3, the normal current range is indicated as 11, 12, . . . , but the actual normal current range table T1 defines the numerical range of the current flowing through the battery assembly 10.

The history unit 74 is composed of, e.g., ROM, RAM, and a hard disk drive (HDD), and records various histories related to the battery device 100. Such history includes, e.g., the results of each abnormality detection in the current detection unit abnormality processing unit 64 and the equalization circuit abnormality processing unit 66. The interface unit 76 communicates with other devices by a wired or wireless means. For example, the history recorded in the history unit 74 is updated through communication with other devices via the interface unit 76.

A-2. Abnormality Determination Process:

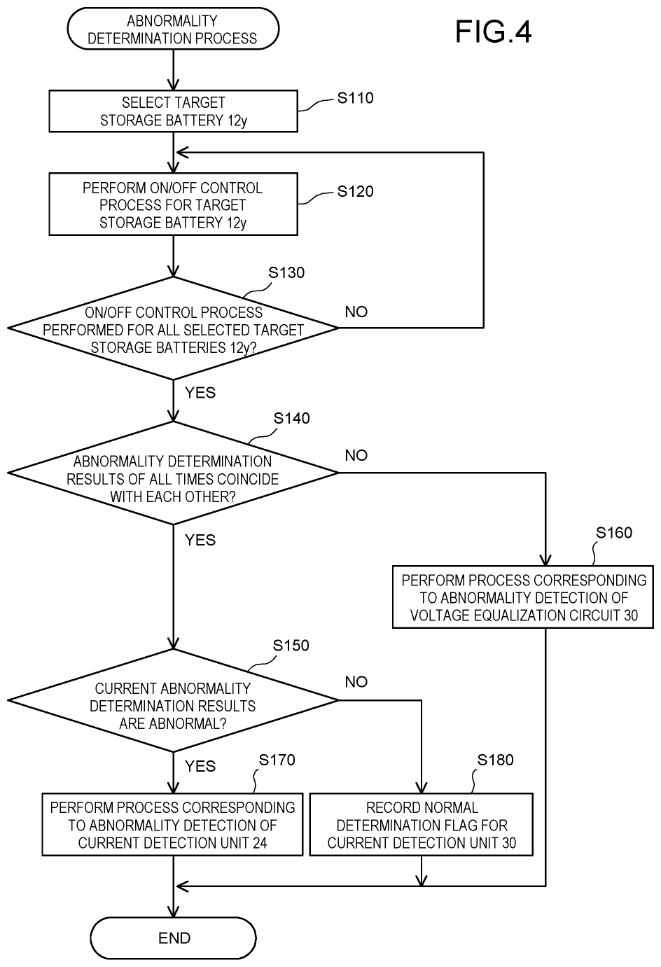

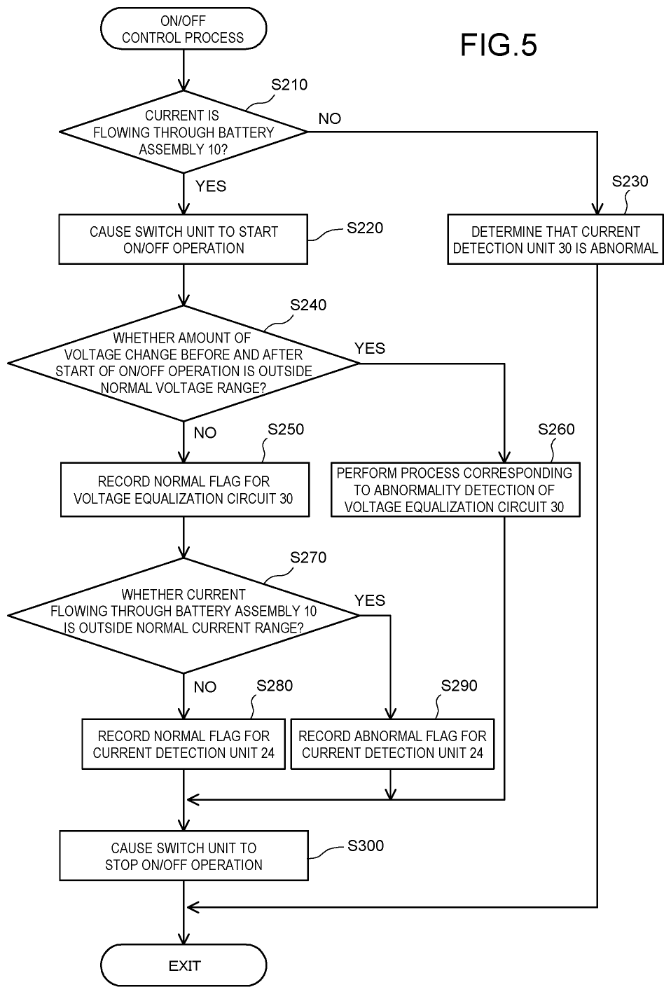

Next, the abnormality determination process performed by the power storage management device 20 in the battery device 100 of this embodiment is described. FIG. 4 is a flowchart illustrating an abnormality determination process performed in the battery device 100 of an embodiment, and FIG. 5 is a flowchart illustrating an on/off control process performed in the battery device 100 of an embodiment. The abnormality determination process is used to determine whether the current detection unit 24 and the voltage equalization circuit 30 are normal or abnormal, thereby performing the process in the event of an abnormality according to the results of the determination. The on/off control process is a process for operating the switch units (first switch 37, second switch 38) corresponding to the selected target storage battery 12y on/off to determine whether the current detection unit 24 and the voltage equalization circuit 30 are normal or abnormal. The abnormality determination process is started, e.g., automatically at the time of activation of the battery device 100, or in response to instructions from the administrator.

When the abnormality determination process (FIG. 4) is started, the on/off control unit 62 (FIG. 1) of the power storage management device 20 selects the target storage battery 12y corresponding to the switch unit to be operated on/off among the plurality of storage batteries 12 (S110). For example, the target storage battery 12y selected by the on/off control unit 62 is the target storage battery 12x described above. In other words, among the plurality of storage batteries 12, the on/off control unit 62 selects, as the target storage battery 12y, the storage battery 12 having a voltage outside the reference voltage range that includes the average voltage value (average voltage Vave) obtained by dividing the voltage of the battery assembly 10 by the total number of storage batteries 12.

Next, the on/off control unit 62 of the power storage management device 20 performs the on/off control process (FIG. 5) for the target storage battery 12y (S120). Here, when there are a plurality of target storage batteries 12y, concerning the plurality of target storage batteries 12y, the on/off control process is performed at different times for the target storage batteries 12y that are adjacent to each other and the on/off control process is performed at the same time for the target storage batteries 12y that are not adjacent to each other. Specifically, when all of the four storage batteries 12 shown in FIG. 1 are target storage batteries 12y, for example, the on/off control process is performed at the same time for the storage battery 12a and the storage battery 12c, and then the on/off control process is performed at the same time for the storage battery 12b and the storage battery 12d.

When the on/off control process is started, as shown in FIG. 5, the control unit 60 (FIG. 1) of the power storage management device 20 determines whether a current is flowing through the battery assembly 10 (S210). Here, as noted above, this abnormality determination process is performed at the time of activation with the line switch 40 in the open state. Therefore, if the current detection unit 24 is normal, no current should be detected in the current detection unit 24. If a current is detected in the current detection unit 24, the current detection unit 24 is in an abnormal state (e.g., a short circuit or an open circuit in the internal circuit or a component failure) and may not be able to perform accurate current detection. The control unit 60 detects the current flowing through the battery assembly 10 based on the signal input from the monitoring unit 28 and determines that no current is flowing through the battery assembly 10 if the current detection value is below a predetermined lower limit (almost zero) or determines that a current is flowing through the battery assembly 10 if the current detection value is greater than the predetermined lower limit.

Upon determining that a current is flowing through the battery assembly 10 (S210: NO), the control unit 60 determines that the current detection unit 24 is in an abnormal state (S230), terminates this on/off control process without starting the on/off operation of the switch unit, and proceeds to S130 in FIG. 4. In S230, the control unit 60 may, e.g., inform the outside world via the interface unit 76 that an abnormal state of the current detection unit 24 has been detected (hereinafter referred to as “abnormality detection”). This prevents the on/off operation of the switch unit corresponding to the target storage battery 12y from being performed even though an abnormality has already been detected by the current detection unit 24.

If the control unit 60 determines that no current is flowing through the battery assembly 10 (S210: YES), the on/off control unit 62 causes the switch unit corresponding to the target storage battery 12y to perform the on/off operation (S220). In this embodiment, the on/off control unit 62 controls the on/off operation of the first switch 37 or the second switch 38 to perform a constant current control that brings the voltage of the target storage battery 12x closer to the average voltage Vave.

Next, the current detection unit abnormality processing unit 64 determines whether the amount of voltage change in the target storage battery 12y caused by the above-mentioned on/off operation of the switch unit is outside the normal voltage range (S240). This determination is made to detect an abnormality in the voltage equalization circuit 30 based on the amount of voltage change in the target storage battery 12y caused by the on/off operation of the switch unit. For example, if the voltage equalization circuit 30 is in an abnormal state (e.g., short circuit or open circuit in the internal circuit or component failure), the amount of voltage change in the target storage battery 12y before and after the start of the on/off operation of the switch unit is outside the normal voltage range.

Specifically, the equalization circuit abnormality processing unit 66 calculates the difference between the voltage of the target storage battery 12y before the start of the on/off operation of the switch unit and the voltage of the target storage battery 12y after the start of the on/off operation of the switch unit (i.e., during the on/off operation), and determines whether the voltage difference is outside the normal voltage range. The normal voltage range is the amount of change in the voltage of the target storage battery 12y that is assumed before and after the start of the on/off operation of the switch unit when the voltage equalization circuit 30 is in a normal state. For example, the normal voltage range is a voltage range (e.g., a numerical value range defined by a voltage drop value ±a predetermined value) including a voltage drop value assumed from the internal resistance value of the target storage battery 12y, the resistance value of the wire 36, and the constant current value of the voltage equalization circuit 30. The determination condition in S240 is an example of the second abnormality determination condition.

If it is determined that the voltage change in the target storage battery 12y before and after the start of the on/off operation of the switch unit is outside the normal voltage range (S240: YES), the equalization circuit abnormality processing unit 66 performs a process corresponding to the abnormality detection of the voltage equalization circuit 30 (S260) and terminates this on/off control process. The process corresponding to the abnormality detection of the voltage equalization circuit 30 is, e.g., the process to report the abnormality detection of the voltage equalization circuit 30 to the outside world via the interface unit 76 or the process to prohibit the closing of the negative terminal 44 or the execution of the voltage equalization process. In this case, the process to detect an abnormality in the current detection unit 24 (S270 to S290) described below is not performed, and the switch unit corresponding to the target storage battery 12y is caused to stop the on/off operation (S300). This is because if the voltage equalization circuit 30 is in an abnormal state, the current detection unit 24 cannot accurately determine the abnormality.

On the other hand, if the voltage equalization circuit 30 is determined to be normal (S240: NO), e.g., the control unit 60 records a flag indicating that the voltage equalization circuit 30 is normal in the history unit 74 (S250). Next, the current detection unit abnormality processing unit 64 determines whether the current flowing through the battery assembly 10 is outside the normal current range during the on/off operation of the switch unit corresponding to the target storage battery 12y (S270). This determination is made to detect an abnormality in the current detection unit 24 based on the current detection value of the current flowing through the battery assembly 10 at the time of the on/off operation of the switch unit. For example, when the current detection unit 24 is in an abnormal state, the current detection value of the current flowing through the battery assembly 10 during the on/off operation of the switch part is outside the normal current range.

Specifically, the current detection unit abnormality processing unit 64 refers to the normal current range table T1 (FIG. 3) to extract the normal current range corresponding to the voltage value of the target storage battery 12y and the voltage value of the battery assembly 10, which are detected during the on/off operation of the switch unit. Next, the current detection unit abnormality processing unit 64 determines whether the current detected value from the current detection unit 24 during the on/off operation of the switch unit is outside the extracted normal current range. The determination condition in S270 is an example of the first abnormality determination condition. The voltage value of the battery assembly 10 can be calculated, e.g., by adding up the voltage detection values of all of the storage batteries 12.

If the current detection value from the current detection unit 24 during the on/off operation of the switch unit is determined to be outside the normal current range (S270: YES), the current detection unit 24 is determined to be abnormal, and for example, the control unit 60 records a flag indicating the abnormality in the current detection unit 24 in the history unit 74 (S290) and proceeds to S300 to complete this on/off control process. On the other hand, if the current detection value from the current detection unit 24 during the on/off operation of the switch unit is determined not to be outside the normal current range (S270: NO), the current detection unit 24 is determined to be normal, and for example, the control unit 60 records a flag indicating the normality of the current detection unit 24 in the history unit 74 (S280) and proceeds to S300 to complete this on/off control process.

Upon completion of this on/off control process, as shown in FIG. 4, the control unit 60 determines whether the on/off control process has been performed for all selected target storage batteries 12y (S130). If it is determined that the on/off control operation has not been performed for all the target storage batteries 12y (S130: NO), the control unit 60 repeats the on/off control operation (S120) for the remaining target storage batteries 12y.

On the other hand, if it is determined that the on/off control process has been performed for all target storage batteries 12y (S130: YES), the equalization circuit abnormality processing unit 66 determines whether the abnormality determination results of the current detection unit 24 (hereinafter referred to as “current abnormality determination results”) in the multiple on/off control process (FIG. 4) performed at different times coincide with each other (S140). If the voltage equalization circuit 30 is normal, the current abnormality determination results of all times should coincide with each other. On the other hand, suppose, for example, that in the voltage equalization circuit 30, the circuit constituting the transformer 39 and the switch unit corresponding to the storage battery 12a is normal, while the circuit constituting the transformer 39 and the switch unit corresponding to the storage battery 12b is abnormal (e.g., disconnected or short-circuited). In addition, suppose that storage batteries 12a, 12b are selected as target storage batteries 12y in S110 and the on/off control process (FIG. 5) is performed at respective different timings. Then, the current error determination result is normal in the on/off control process for the storage battery 12a, while the current error determination result is abnormal in the on/off control process for the storage battery 12b, and as a result, the current error determination results do not coincide with each other. It should be noted that the equalization circuit abnormality processing unit 66 is able to make the determination based on the flags (S280, S290) indicating abnormalities in the current detection unit 24 recorded in the history unit 74. If the on/off control process (FIG. 5) has been performed only once in the abnormality determination process, S140 may be determined as “YES”. The determination condition in S140 is an example of the third abnormality determination condition.

If it is determined that the multiple times of current abnormality determination results include a current abnormality determination result that is different from the other times (S140: NO), the equalization circuit abnormality processing unit 66 performs a process corresponding to the abnormality detection of the voltage equalization circuit 30 (S160) to complete this abnormality determination process. The process corresponding to the abnormality detection of the voltage equalization circuit 30 is, e.g., the process to report the abnormality detection of the voltage equalization circuit 30 to the outside world via the interface unit 76.

On the other hand, if it is determined that the current abnormality determination results of all times coincide with each other (S140: YES), then it is determined whether the current abnormality determination results are abnormal (S150). If the current abnormality determination results are determined to be abnormal (S150: YES), the current detection unit abnormality processing unit 64 performs the process corresponding to the abnormality detection of the current detection unit 24 (S170) to complete this abnormality determination process. The process corresponding to the abnormality detection of the current detection unit 24 is, e.g., the process to report the abnormality detection of the current detection unit 24 to the outside world via the interface unit 76 or the process to prohibit charging/discharging of the battery assembly 10. On the other hand, if the current abnormality determination result is determined to be normal (S150: NO), e.g., the control unit 60 records a flag indicating the determination that the current detection unit 24 is in a normal state (S180) in the recording unit 72 to complete this abnormality determination process. This allows, e.g., the voltage equalization process, among others, to be performed.

A-3. Effects of this Embodiment:

As explained above, in this embodiment of the power storage management device 20, the second winding 39j of each transformer 39 is connected in parallel not only with the battery assembly 10 but also with the current detection unit 24, as shown in FIG. 1. In this configuration, upon an on/off operation of the switch units constituting the voltage equalization circuit 30, a current is transferred between the target storage battery 12y corresponding to that switch unit and the battery assembly 10. As a result, the voltage of the target storage battery 12y changes. In this case, if the current detection unit 24 is normal, the detection result of the current detection unit 24 will be within the normal current range corresponding to the voltage of the target storage battery 12y and the voltage of the battery assembly 10 based on the detection result of the voltage detection unit 22 (S270: NO in FIG. 5), and if the current detection unit 24 is abnormal, the detection result of the current detection unit 24 will be outside the normal current range (S270: YES in FIG. 5).

The inventor newly discovered that the presence or absence of an abnormality in the current detection unit 24 can be determined by focusing on the voltage change in the target storage battery 12y caused by the on/off operation of the voltage equalization circuit 30 and the detection result of the current detection unit 24. As a result, this embodiment is able to determine the presence or absence of an abnormality in the current detection unit 24 by using the voltage equalization circuit 30 without providing a separate current path dedicated to determining whether there is an abnormality in the current detection unit 24.

In this embodiment, the current detection unit 24 is determined to be in an abnormal state (S290) under the necessary conditions that there is a voltage change in the target storage battery 12y caused by the on/off operation of the switch units (S240: NO) and that the detection result of the current detection unit 24 is outside the normal current range (S270: YES) in the on/off control process (FIG. 5). Thus, this embodiment is able to suppress that the current detection unit 24 is erroneously determined as abnormal when the voltage equalization circuit 30 is abnormal.

In this embodiment, if the amount of voltage change in the target storage battery 12y before and after the start of on/off operation of the switch unit is determined to be outside the normal voltage range (S240: YES) in the on/off control process (FIG. 5), the equalization circuit abnormality processing unit 66 performs a process corresponding to the abnormality detection of the voltage equalization circuit 30 (S260). As a result, according to this embodiment, in addition to an abnormality in the current detection unit 24, an abnormality in the voltage equalization circuit 30 can also be detected.

In this embodiment, in the abnormality determination process (FIG. 4), the on/off control unit 62 selects, among the plurality of storage batteries 12, the storage battery 12 having a voltage outside the reference voltage range as the target storage battery 12y (S110). In other words, the switch unit corresponding to the storage battery 12 that requires a voltage equalization process is operated on and off to determine the presence or absence of abnormality in the current detection unit 24. As a result, according to this embodiment, compared to the configuration in which the target storage battery 12y is selected regardless of whether the voltage is within the reference voltage range, the presence or absence of an abnormality in the current detection unit 24 can be determined by using the voltage equalization circuit 30 while suppressing the on/off operation of the switch unit, which is essentially unnecessary in the voltage equalization process.

In this embodiment, when it is determined in the abnormality determination process (FIG. 4) that multiple times of current abnormality determination results include a current abnormality determination result that is different from that of the other times (S140: NO), the equalization circuit abnormality processing unit 66 performs a process corresponding to the abnormality detection of the voltage equalization circuit 30 (S160). According to this embodiment, in addition to an abnormality in the current detection unit 24, an abnormality in the voltage equalization circuit 30 can also be detected.

As described above, in the battery device 100 of this embodiment, when the switch units corresponding to mutually adjacent storage batteries 12 are operated on and off at the same time, the voltage of each storage battery 12 cannot be measured accurately because the voltage drops in the wires 36 (resistive component) in the common path cancel each other out, and as a result, it may be impossible to accurately determine the presence or absence of an abnormality in the current detection unit 24. In contrast, in this embodiment, in the abnormality determination process (FIG. 4), when there are a plurality of target storage batteries 12y, the on/off control processes are performed at different times for the target storage batteries 12y that are adjacent to each other among the plurality of target storage batteries 12y. This can suppress the decline in accuracy of determining the presence or absence of an abnormality in the current detection unit 24.

B. Modifications:

The technology disclosed herein is not limited to the embodiments described above but can be modified into various forms without departing from the spirit of the present invention, for example, the following modifications are possible.

The configuration of the battery device 100 in the above embodiments is only an example and may be modified in various ways. For example, in each of the above embodiments, the number of storage batteries 12 constituting the battery assembly 10 may be modified as desired. In each of the above embodiments, the storage battery 12 is shown as an example of the storage element, but the storage element may be a capacitor, for example. In each of the above embodiments, the battery assembly 10 is illustrated as the power storage unit, but the power storage unit may be a group of capacitors in which a plurality of capacitors are connected in series. In the above embodiments, the voltage equalization circuit 30 may be configured without either the first switch 37 or the second switch 38.

In each of the above embodiments, the contents of the normal current range table T1 is only an example and may be modified in various ways. The normal current range table T1 does not need to be recorded in the recording unit 72. In any of the above embodiments, at least one of the functional units of the control unit 60 may be omitted.

The contents of the abnormality determination process in each of the above embodiments are examples only and may be modified in various ways. For example, in the above embodiments, the configuration may be such that the abnormality detection of the voltage equalization circuit 30 is not performed. In the above embodiment, the abnormality determination process may be performed in parallel with the voltage equalization process, which is performed, e.g., when a voltage difference among the plurality of storage batteries 12 constituting the battery assembly 10 is detected to be larger than a predetermined threshold value, or the abnormality determination process may be separately performed at a different time from the voltage equalization process. In addition, although the abnormality determination process is performed under the condition that the line switch 40 is in the open state to detect an abnormality in the current detection unit 24 with high accuracy, the abnormality determination process may also be performed when the line switch 40 is in the closed state.

In the above embodiment, in S110 of the abnormality determination process, the on/off control unit 62 may select, for example, any one of the plurality of storage batteries 12 as the target storage battery 12y, regardless of the voltage value. In S120, the on/off control unit 62 may perform the on/off control process at the same time for the target storage batteries 12y that are adjacent to each other among the plurality of target storage batteries 12y.

In the above embodiment, in S240 of the on/off control process, it is determined whether the voltage change in the target storage battery 12y before and after the start of the on/off operation of the switch unit is outside the normal voltage range as the amount of voltage change in the target storage battery 12y caused by the on/off operation of the switch unit, but it may be determined whether the voltage change in the target storage battery 12y before the start of the on/off operation of the switch unit and after the end of the on/off operation is outside the normal voltage range.

In the above embodiment, in S140, it is determined whether the current abnormality determination results of the on/off control processes performed at different times for different target storage batteries 12y coincide with each other, but it is also possible to determine whether the current abnormality determination results of the on/off control processes performed at different times for the same target storage battery 12y coincide with each other.

### REFERENCE SIGNS LIST

10: battery assembly, 12: storage battery, 12x, 12y: target storage battery, 20: power storage management device, 22: voltage detection unit, 24: current detection unit, 28: monitoring unit, 30: voltage equalization circuit, 36: wire, 37: first switch, 38: second switch, 39: transformer, 39i: first winding, 39j: second winding, 40: line switch, 42: positive terminal, 44: negative terminal, 60: control unit, 62: on/off control unit, 64: current detection unit abnormality processing unit, 66: equalization circuit abnormality processing unit, 72: recording unit, 74: history unit, 76: interface unit, 100: battery device, T1: normal current range table

1. A power storage management device that manages a power storage unit in which a plurality of power storage elements are connected in series, the power storage management device comprising:
a voltage detection unit that detects a voltage of each of the plurality of power storage elements;
a current detection unit that is connected in series with the power storage unit to detect a current flowing through the power storage unit;
a voltage equalization circuit that comprises a plurality of transformers provided corresponding to each of the plurality of power storage elements, each of the plurality of transformers comprising a first winding connected in parallel with each of the power storage elements and a second winding connected in parallel with the power storage unit and the current detection unit, and a plurality of switch units provided corresponding to each of the plurality of power storage elements, each of the plurality of switch units comprising at least one of a first switch connected in series to the first winding and a second switch connected in series to the second winding, to reduce the voltage difference among the plurality of power storage elements;
an on/off control unit that selects some of power storage elements among the plurality of power storage elements as target power storage elements and causes the switch units corresponding to the target power storage elements to perform on/off operation; and
a first abnormality processing unit that performs a process corresponding to an abnormality detection of the current detection unit when a first abnormality determination condition is satisfied, the first abnormality determination condition including the necessary condition that a detection result of the current detection unit caused by the on/off operation of the switch units is outside a normal current range corresponding to the voltage of the target power storage elements and the voltage of the power storage unit based on the detection result of the voltage detection unit.

2. The power storage management device according to claim 1, wherein
the first abnormality determination condition includes the necessary conditions that there is a voltage change in the target power storage elements caused by the on/off operation of the switch units and that the detection result of the current detection unit is outside the normal current range.

3. The power storage management device according to claim 1, further comprising:
a second abnormality processing unit that performs a process corresponding to an abnormality detection of the voltage equalization circuit when a second abnormality determination condition is satisfied, the second abnormality determination condition including the necessary condition that an amount of voltage change in the target power storage elements caused by the on/off operation of the switch unit is outside a normal voltage range.

4. The power storage management device according to claim 1, wherein
the on/off control unit selects, among the plurality of power storage elements, a power storage element having a voltage outside a reference voltage range that includes an average voltage value obtained by dividing the voltage of the power storage unit by the number of power storage elements as the target power storage elements.

5. The power storage management device according to claim 1, further comprising:
a third abnormality processing unit that performs a process corresponding to an abnormality detection of the voltage equalization circuit when a third abnormality determination condition is satisfied, the third abnormality determination condition including at least one of the necessary conditions that abnormality detection results of the current detection unit when the same switch of the plurality of switch units is operated on and off multiple times differ from each other and that abnormality detection results of the current detection unit when at least two or more switch units are operated on and off sequentially differ from each other.

6. The power storage management device according to claim 1, wherein
when the target power storage elements include a first power storage element and a second power storage element that are adjacent to each other, the on/off control unit performs the on/off operation of the switch unit corresponding to the first power storage element and the on/off operation of the switch unit corresponding to the second power storage element at different times.

7. A power storage device, comprising:
a power storage unit comprising a plurality of power storage elements connected in series; and
the power storage management device according to claim 1.

8. A method for managing a power storage unit, the power storage unit comprising:
a power storage unit comprising a plurality of power storage elements connected in series;
a voltage detection unit that detects a voltage of each of the plurality of power storage elements;
a current detection unit connected in series with the power storage unit to detect a current flowing through the power storage unit; and
a voltage equalization circuit that comprises a plurality of transformers provided corresponding to each of the plurality of power storage elements, each of the plurality of transformers comprising a first winding connected in parallel with each of the power storage elements and a second winding connected in parallel with the power storage unit and the current detection unit, and a plurality of switch units provided corresponding to each of the plurality of power storage elements, each of the plurality of switch units comprising at least one of a first switch connected in series to the first winding and a second switch connected in series to the second winding, to reduce the voltage difference among the plurality of power storage elements, the method comprising:
a step of selecting some of power storage elements among the plurality of power storage elements as target power storage elements and causing the switch unit corresponding to the target power storage elements to perform on/off operation; and
a step of performing a process corresponding to an abnormality detection of the current detection unit when a first abnormality determination condition is satisfied, the first abnormality determination condition including the necessary condition that a detection result of the current detection unit caused by the on/off operation of the switch units is outside a normal current range corresponding to the voltage of the target power storage elements and the voltage of the power storage unit based on the detection result of the voltage detection unit.

9. The power storage management device according to claim 2, further comprising:
a second abnormality processing unit that performs a process corresponding to an abnormality detection of the voltage equalization circuit when a second abnormality determination condition is satisfied, the second abnormality determination condition including the necessary condition that an amount of voltage change in the target power storage elements caused by the on/off operation of the switch unit is outside a normal voltage range.

10. The power storage management device according claim 2, wherein
the on/off control unit selects, among the plurality of power storage elements, a power storage element having a voltage outside a reference voltage range that includes an average voltage value obtained by dividing the voltage of the power storage unit by the number of power storage elements as the target power storage elements.

11. The power storage management device according claim 3, wherein
the on/off control unit selects, among the plurality of power storage elements, a power storage element having a voltage outside a reference voltage range that includes an average voltage value obtained by dividing the voltage of the power storage unit by the number of power storage elements as the target power storage elements.

12. The power storage management device according to claim 2, further comprising:
a third abnormality processing unit that performs a process corresponding to an abnormality detection of the voltage equalization circuit when a third abnormality determination condition is satisfied, the third abnormality determination condition including at least one of the necessary conditions that abnormality detection results of the current detection unit when the same switch of the plurality of switch units is operated on and off multiple times differ from each other and that abnormality detection results of the current detection unit when at least two or more switch units are operated on and off sequentially differ from each other.

13. The power storage management device according to claim 3, further comprising:
a third abnormality processing unit that performs a process corresponding to an abnormality detection of the voltage equalization circuit when a third abnormality determination condition is satisfied, the third abnormality determination condition including at least one of the necessary conditions that abnormality detection results of the current detection unit when the same switch of the plurality of switch units is operated on and off multiple times differ from each other and that abnormality detection results of the current detection unit when at least two or more switch units are operated on and off sequentially differ from each other.

14. The power storage management device according to claim 4, further comprising:
a third abnormality processing unit that performs a process corresponding to an abnormality detection of the voltage equalization circuit when a third abnormality determination condition is satisfied, the third abnormality determination condition including at least one of the necessary conditions that abnormality detection results of the current detection unit when the same switch of the plurality of switch units is operated on and off multiple times differ from each other and that abnormality detection results of the current detection unit when at least two or more switch units are operated on and off sequentially differ from each other.

15. The power storage management device according to claim 2, wherein
when the target power storage elements include a first power storage element and a second power storage element that are adjacent to each other, the on/off control unit performs the on/off operation of the switch unit corresponding to the first power storage element and the on/off operation of the switch unit corresponding to the second power storage element at different times.

16. The power storage management device according to claim 3, wherein
when the target power storage elements include a first power storage element and a second power storage element that are adjacent to each other, the on/off control unit performs the on/off operation of the switch unit corresponding to the first power storage element and the on/off operation of the switch unit corresponding to the second power storage element at different times.

17. The power storage management device according to claim 4, wherein
when the target power storage elements include a first power storage element and a second power storage element that are adjacent to each other, the on/off control unit performs the on/off operation of the switch unit corresponding to the first power storage element and the on/off operation of the switch unit corresponding to the second power storage element at different times.

18. The power storage management device according to claim 5, wherein
when the target power storage elements include a first power storage element and a second power storage element that are adjacent to each other, the on/off control unit performs the on/off operation of the switch unit corresponding to the first power storage element and the on/off operation of the switch unit corresponding to the second power storage element at different times.
